(19) United States
(12) Patent Application Publication
(10) Pub. No.: US 2008/0062829 A1
(43) Pub. Date: Mar. 13, 2008

(54) METHOD AND APPARATUS FOR DETERMINING START OF USER DATA IN ONE DATA BLOCK OF OPTICAL DISC BY DETECTING SYNC PATTERNS DISPOSED BETWEEN TWO DATA BLOCKS

(76) Inventor: Jin-Bin Yang, Changhua County (TW)

Correspondence Address: NORTH AMERICA INTELLECTUAL PROPERTY CORPORATION, P.O. BOX 506, MERRIFIELD, VA, 22116, US

(21) Appl. No.: 11/531,280

(22) Filed: Sep. 13, 2006

(51) Int. Cl. G11B 19/02

(52) U.S. Cl. 369/47.1; 369/59.25

(57) ABSTRACT

A first method for determining the start of user data in a data block on an optical disc is disclosed. The first method includes: setting a plurality of predetermined time intervals; detecting a first sync pattern and a second sync pattern; and utilizing one of the predetermined time intervals and a time interval between the first sync pattern and the second sync pattern to determine the start of the user data. In addition, a second method for determining the start of user data in a data block on an optical disc is disclosed. The second method includes: detecting a first sync pattern; when the first sync pattern is found, detecting a sync ID of the first sync pattern; and when the sync ID of the first sync pattern is found, determining the start of the user data according to the sync ID of the first sync pattern.

### BACKGROUND

The present invention relates to sync pattern detection, and more particularly, to a method and apparatus for detecting the start of user data of a Blu-ray disc.

With increasing research and development in the field of optical storage technology, a new generation of optical discs has been developed. Blu-ray discs are at the forefront of the optical disc revolution, offering great storage capacity and superior audio-visual quality.

A Blu-ray disc format has two sync marks or patterns in a run-in area and one sync mark/pattern at the beginning of a data block (i.e. a cluster). Sequentially, these sync patterns have sync ID sync_1, sync_2, and FS0. Since the user data lies directly after the third sync pattern, the position of the third sync pattern needs to be known in order to start data decoding. Please refer to FIG. 1. FIG. 1 is a diagram illustrating sync patterns on a Blu-ray disc according to the related art. As shown in FIG. 1, two sync patterns sync_1 and sync_2 are recorded in the run-in area on the Blu-ray disc, while a sync pattern FS0 is recorded at the beginning of a data block on the Blu-ray disc. The sync patterns sync_, sync_2, and FS0 each have a time interval 30T. If the position of the third sync pattern, i.e. FS0, is not known, this will affect the determination of data address information. As the data needs to be moved from a buffer to a DRAM for decoding, without the relevant address information the buffer may crash. Although address information can be obtained according to previous addresses or next addresses, this requires more complicated hardware. Therefore, a novel detection scheme for identifying the start of user data stored in each data block (cluster) is required.

### SUMMARY

Therefore, it is an objective of the present invention to provide a method and apparatus for determining the start of user data of a Blu-ray disc that solve the above-mentioned problems.

Briefly described, according to an embodiment of the present invention, a first apparatus for determining the start of user data in a data block on an optical disc is disclosed. The first apparatus comprises: a detection module, for detecting a first specific pattern and a second specific pattern; a time interval indication module, coupled to the detection module, for indicating a time interval between two specific patterns detected by the detection module, and determining the start of the user data by utilizing one of a plurality of predetermined time intervals and a time interval between the first specific pattern and the second specific pattern.

In addition, a first method for determining the start of user data in a data block on an optical disc is disclosed. The first method includes: setting a plurality of predetermined time intervals; detecting a first specific pattern and a second specific pattern; and utilizing one of the predetermined time intervals and a time interval between the first specific pattern and the second specific pattern to determine the start of the user data.

Further, a second method for determining the start of user data in a data block on an optical disc is disclosed. The second method includes: detecting a first specific pattern; when the first specific pattern is found, detecting an ID of the first specific pattern; and when the ID of the first specific pattern is found, determining the start of the user data according to the ID of the first specific pattern.

The present disclosure advantageously enables data on a Blu-ray disc to be accurately decoded while reducing the complexity of locating the start of user data in a cluster. Furthermore, the present disclosure enables data to be accurately decoded without requiring the detection of all three sync patterns.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a diagram illustrating sync patterns on a Blu-ray disc according to the related art.

FIG. 2 is a diagram of an apparatus for detecting the start of user data on a Blu-ray disc according to a first embodiment of the present invention.

FIG. 3 is a flow chart illustrating the method of detecting the start of user data.

FIG. 4 is a diagram of an apparatus for detecting the start of user data of a Blu-ray disc according to a second embodiment of the present invention.

FIG. 5 is a diagram of an apparatus for detecting the start of user data of a Blu-ray disc according to a third embodiment of the present invention.

FIG. 6 is a diagram of an apparatus for detecting the start of user data of a Blu-ray disc according to a fourth embodiment of the present invention.

FIG. 7 is a diagram of an apparatus for detecting the start of user data of a Blu-ray disc according to a fifth embodiment of the present invention.

### DETAILED DESCRIPTION

Certain terms are used throughout the following description and claims to refer to particular system components. As one skilled in the art will appreciate, consumer electronic equipment manufacturers may refer to a component by different names. This document does not intend to distinguish between components that differ in name but not function. In the following discussion and in the claims, the terms “including” and “comprising” are used in an open-ended fashion, and thus should be interpreted to mean “including, but not limited to . . . ” The terms “couple” and “couples” are intended to mean either an indirect or a direct electrical connection. Thus, if a first device couples to a second device, that connection may be through a direct electrical connection, or through an indirect electrical connection via other devices and connections.

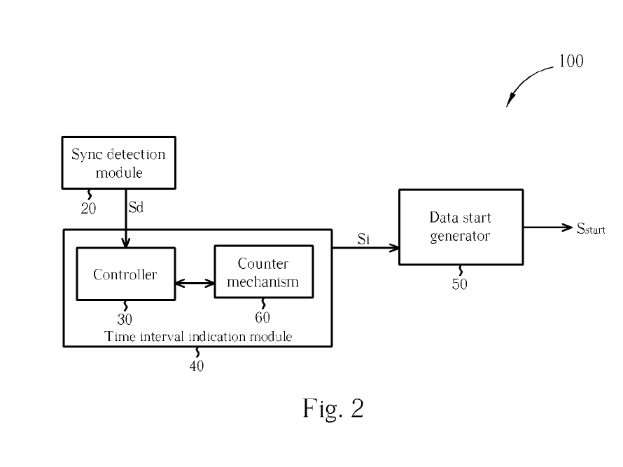

Please refer to FIG. 2. FIG. 2 is a diagram of an apparatus 100 for detecting the start of user data of a Blu-ray disc according to a first embodiment of the present invention. The apparatus 100 comprises a sync detection module 20 for detecting specific patterns/marks (i.e. sync patterns) and outputting a first signal S_{d} to indicate a detection result; a time interval indication module 40, for determining a time interval between two sync patterns, utilizing the time interval to determine a time interval between a sync pattern and the start of user data, and outputting a second signal Sᵢ when the third sync pattern is detected or a determined time interval is met; and a data start generator 50, for identifying the start of user data stored in a data block according to the indication result Sᵢ from the time interval indication module 40, and sending a signal Sₛₜₐᵣₜ. In this embodiment, the time interval indication module 40 comprises a controller 30 and a counter mechanism 60. The controller 30 sets a plurality of counter threshold values to the counter mechanism 60 according to a plurality of predetermined time intervals, and the counter mechanism 60 outputs a counting result to the controller 30, and the sync detection module 20 each time the counter threshold is met. Once the sync detection module 20 detects the third sync pattern or the determined time interval is met, the time interval indication module 40 will output the second signal Sᵢ to the data start generator 50. The operation of detecting the start of user data stored in a data block (i.e. a cluster, for Blu-ray disc) is detailed as below. Please note that it is not always necessary to detect the third sync pattern FS0 for determining the start of user data. The step of detecting the third sync pattern FS0 is just one embodiment of the present invention. In other embodiments, the disclosed invention can similarly utilize known time intervals for directly determining the start of data, thereby avoiding the step of detecting FS0.

Please note that logical data blocks defined by Blu-ray disc specification are called clusters. However, the present invention is not limited to detect the start of user data stored in a cluster on a Blu-ray disc; in other words, the disclosed detecting mechanism can be applied to other optical discs to identify the start of user data, which still obeys the spirit of the present invention.

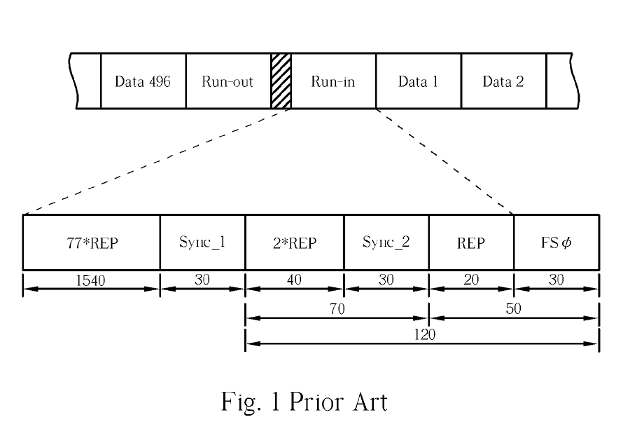

In this embodiment, the sync detection module 20 is designed to have a sync ID determination unit (not shown) to support the sync ID detection requirements. However, as detailed later, the sync ID detection capability is optional for some data start detection scenarios; in other words, the sync detection module 20 is allowed to exclude the sync ID detection capability when data start detection scenarios, which do not rely on sync ID, are adopted. The inclusion of this sync ID determination unit means that the start of the user data can be determined when at least one sync pattern is detected. The controller 30 sequentially sets a plurality of counter threshold values to the counter mechanism 60 according to a plurality of predetermined time intervals, relating to time intervals between sync patterns and time intervals between sync patterns and the data block. These time intervals are according to known parameters of the run-in areas of a Blu-ray disc. Throughout this disclosure, the predetermined time intervals are set by 50T, 70T, and 120T according to the disc structure shown in FIG. 1, where an interval between sync patterns having sync IDs sync_1 and sync_2 is 70T, an interval between sync patterns having sync IDs sync_2 and FS0 is 50T, and an interval between sync patterns having sync IDs sync_1 and FS0 is 120T.

In a first data start detection scenario of the present invention, the sync detection module 20 searches for a sync pattern and identifies a sync ID when the sync pattern is detected. The sync ID information of the detected sync pattern is transmitted to the time interval indication module 40. As one can see from the disc structure shown in FIG. 1, when a sync ID of a detected sync pattern is determined, an interval between the detected sync pattern and the start of data can be easily determined by the controller 30. For example, assume that the first sync pattern sync_1 is detected and its sync ID ‘sync_1 ’ is identified by the sync detection module 20. After receiving the sync ID information from the sync detection module 20, the time interval indication module 40 realizes that a time interval between the first sync pattern sync_1 and FS0 is equal to 120T. Therefore, after waiting 120T from the detection of the first sync pattern sync_, the time interval indication module 40 determines whether a sync pattern has been detected by the sync detection module 20, wherein if the sync pattern is detected, signal S_{d} will be sent to the time interval indication module 40, and signal Sᵢ will be output to the data start generator 50, instructing the data start generator 50 to output a data start signal Sₛₜₐᵣₜ. Similarly, if the second sync pattern sync_2 is detected and its sync ID ‘sync_2’ is identified, the time interval indication module 40 realizes that a time interval between the second sync pattern sync_2 and FS0 is equal to 50T, and if the third sync pattern FS0 is detected and its sync ID ‘FS0’ is identified after 50T, the time interval indication module 40 will send the signal Sᵢ to the data start generator. Please note that the detection of the third sync pattern FS0 is utilized in some embodiments as a confirmation/check, and is not a requirement of the disclosed system. As there may be some small variation in time intervals between sync patterns, detection of the third sync pattern FS0 ensures that the start of user data can be determined very accurately. Other embodiments that do not include detection of the third sync pattern FS0 still fall within the scope of the present invention. In short, even though only one sync pattern (e.g. the sync pattern sync_1) is detected successfully, the first data start detection scenario can guarantee that the start of user data be correctly determined.

In the above first data start detection scenario, protection schemes are provided to make the detection of the start of user data more accurate. In a first protection scheme, the time interval indication module 40 is allowed to trigger the data start generator 50 when a plurality of sync IDs are identified by the sync detection module 20. For example, if the sync detection module 20 successfully and sequentially detects sync IDs ‘sync_1’, and ‘sync_2’, the time interval indication module 40 outputs the signal Sᵢ after waiting 50T; if the sync detection module 20 successfully and sequentially detects sync IDs ‘sync_1 ’ and ‘FS0’, the time interval indication module 40 outputs the signal Sᵢ immediately; if the sync detection module 20 successfully and sequentially detects sync IDs ‘sync_2’ and ‘FS0’, the time interval indication module 40 outputs the signal Sᵢ immediately; and if the sync detection module 20 successfully and sequentially detects all sync IDs ‘sync_1’, ‘sync_2’, the ‘FS0’, the time interval indication module 40 outputs the signal Sᵢ immediately.

In a second protection scheme in the first data start detection scenario, a time interval between detected sync patterns is referenced to invalidate a detection result generated from the sync detection module 20. Combining the first and second protection schemes offers better sync pattern detection accuracy. When the second protection scheme is implemented, the sync detection module 20 notifies the controller 30 each time a sync pattern is detected. When the signal S_{d} is received by the time interval indication module 40, the controller 30 sets/updates a counter threshold value set to the counter mechanism 60 according to one of the predetermined time intervals 50T, 70T, and 120T. In other words, the counter mechanism 60 notifies the controller 30 when the predetermined time interval 50T expires, the predetermined time interval 70T expires, or the predetermined time interval 120T expires. The controller 30 will select one of the predetermined time intervals 50T, 70T, and 120T to monitor the sync pattern detection according to the timer notification from the counter mechanism 60. For example, when the sync detection module 20 detects the sync pattern sync_1 and identifies its sync ID ‘sync_1’, the controller 30 assigns the counter mechanism 60 two counter threshold values corresponding to predetermined time intervals 70T and 120T, respectively, and then the counter mechanism 60 starts counting. Since the currently detected sync pattern is the sync pattern sync_1, the controller 30 sequentially selects the predetermined time intervals 70T and 120T to monitor the sync pattern detection. Therefore, as the predetermined time interval 70T expires, the counter mechanism 60 notifies the controller 30. At the time, if the sync detection module 20 detects the sync pattern sync_2 and identifies its sync ID ‘sync_2’, the time interval indication module 40 is allowed to trigger the data start generator after waiting 50T. However, if the sync detection module 20 fails to detect the sync pattern sync_2, the counter mechanism 60 keeps counting and the controller 30 selects the predetermined time interval 120T to monitor the sync pattern detection. When the predetermined time interval 120T expires, the counter mechanism 60 notifies the controller 30. At the time, if the sync detection module 20 detects the sync pattern FS0 and identifies its sync ID ‘FS0’, the time interval indication module 40 is allowed to trigger the data start generator immediately. In this protection scheme it is not always necessary to detect FS0 for determining the start of user data. Based on the above teachings, it is obvious that the second protection scheme can be applied to sync ID detection of any two sync patterns and sync ID detection of all three sync patterns. Therefore, further description is omitted for brevity. As mentioned above, the second protection scheme is utilized to check the time interval between two detected sync patterns for further confirming whether the latter one is a valid sync pattern, and is optional depending on design requirements.

In a second data start detection scenario of the present invention, the sync detection module 20 does not enable the sync ID determination capability or is not designed to have this function. In this case the controller 30 will set counter threshold values to the counter mechanism 60 each time a sync pattern is detected by the sync pattern module 20. It should be noted that since the sync ID is not determined, the time interval information associated with two detected sync patterns is crucial to the second data start detection scenario for judging the start of user data. In other words, the time interval information is used to identify which sync patterns are detected. For example, if the sync detection module 20 detects the first sync pattern sync_1, it will notify the controller 30 by sending signal S_{d}. Please note that no sync ID is provided to the data start generator 50 and the controller 30. Therefore, the identity of the currently detected sync pattern is unknown to the components in the apparatus 100. When notified by the sync detection module 20, the controller 30 sets/updates a counter threshold value set to the counter mechanism 60 according to the predetermined time intervals 50T, 70T, and 120T. In other words, the counter mechanism 60 notifies the controller 30 when the predetermined time interval 50T expires, the predetermined time interval 70T expires, and the predetermined time interval 120T expires. The controller 30 will select the predetermined time intervals 50T, 70T, and 120T orderly to monitor the sync pattern detection according to the timer notification given from the counter mechanism 60.

For example, when the predetermined time interval 50T expires, the running counter mechanism 60 notifies the controller 30. However, if no sync pattern is detected, i.e. the sync detection module 20 does not trigger the first signal S_{d} to the data start generator 50 and the controller 30, the counter mechanism 60 keeps counting and the controller 30 selects the predetermined time interval 70T to monitor the sync pattern detection. When the predetermined time interval 70T expires, the running counter mechanism 60 notifies the controller 30 again. At this time, if the sync detection module 20 detects a sync pattern and notifies the controller 30, the controller 30 realizes that currently detected sync pattern is the second sync pattern sync_2 and the initially detected sync pattern is the first sync pattern sync_1. In this case, the time interval indication module 40 will trigger the data start generator after waiting a further 50T. In another case where no sync pattern is detected when the predetermined time interval 70T expires, the counter mechanism 60 keeps counting and the controller 30 selects the predetermined time interval 120T to monitor the sync pattern detection. When the predetermined time interval 120T expires, the running counter mechanism 60 notifies the controller 30 again. At this time, if the sync detection module 20 detects a sync pattern and notifies the controller 30, the controller 30 realizes that currently detected sync pattern is the third sync pattern FS0 and the initially detected sync pattern is the first sync pattern sync_1. Therefore, the time interval indication module 40 will trigger the data start generator 50 immediately. Similarly, according to the above disclosure, if the time interval between two detected sync patterns is 50T, the controller 30 realizes that currently detected sync pattern is the third sync pattern FS0 and the initially detected sync pattern is the second sync pattern sync_2, and triggers the data start signal generator 50 immediately.

In the second data start detection scenario, a protection scheme is provided to make the detection of the start of user data more accurate. The protection scheme requires that three sync patterns are detected, and each time interval between two detected sync patterns is correct. For instance, if the sync detection module 20 detects the first sync pattern sync_, it will notify the data start generator 50 and the controller 30. The counter mechanism 60 begins counting and the controller 30 selects the predetermined time interval 50T to monitor the sync pattern detection. When the predetermined time interval 50T expires, the running counter mechanism 60 notifies the controller 30. However, no sync pattern is detected. The counter mechanism 60 keeps counting and the controller 30 selects the predetermined time interval 70T to monitor the sync pattern detection. When the predetermined time interval 70T expires, the running counter mechanism 60 notifies the controller 30 again. At this time, the sync detection module 20 detects a sync pattern and notifies the controller 30, so the controller 30 realizes that currently detected sync pattern is the second sync pattern sync_2 and the initially detected sync pattern is the first sync pattern sync_1. In this case, the data start generator 50 is not ready to determine the start of user data yet because only two sync patterns are detected, and therefore the signal Sᵢ has not been output by the time interval indication module 40. It should be noted that the sync detection module 20 will notify the controller 30 when a sync pattern (i.e. the second sync pattern sync_2) is detected. The controller 30 will reset the counter mechanism 60 and re-assign a counter threshold value to the counter mechanism 60 for counting the predetermined time intervals 50T, 70T, and 120T again. That is, the counter mechanism 60 will notify the controller 30 each time one of the predetermined time intervals 50T, 70T, and 120T expires. Later, when the predetermined time interval 50T expires, the running counter mechanism 60 notifies the controller 30 via the second signal Sᵢ. At this time, the sync detection module 20 detects a sync pattern and notifies the controller 30, the controller 30 realizes that currently detected sync pattern is the third sync pattern FS0. Therefore, the time interval indication module 40 will trigger the data start generator 50 immediately because all of the sync patterns are detected and the time intervals are correct.

In addition to the above first and second data start detection scenarios, the present invention discloses a third data start detection scenario that combines features of the first and second data start detection scenarios. For example, in an embodiment of the third data start detection scenario, the first data start detection scenario is first used to detect the first sync pattern sync_1 and its associated sync ID ‘sync_1’, and then the second data start detection scenario, which does not detect the sync ID, takes over to complete the determination of the start of user data in a data block on a Blu-ray disc. Based on the above teachings, persons skilled in this art can realize other combinations of features of the first and second data start detection scenarios are possible, and further description is omitted here for brevity. Any alternative designs combining features of the first and second data start detection scenarios fall in the scope of the present invention.

Please note that in the above description, the predetermined time intervals are set by 50T, 70T, 120T. However, the controller 30 could be designed to allow a tolerance range when detecting whether a sync pattern occurs when a specific predetermined time interval expires. For example, the predetermined time intervals referenced by the controller 30, in other embodiments, could be 50T±nT, 70T±nT, 120T±nT, where n is adjustable according to different design requirements.

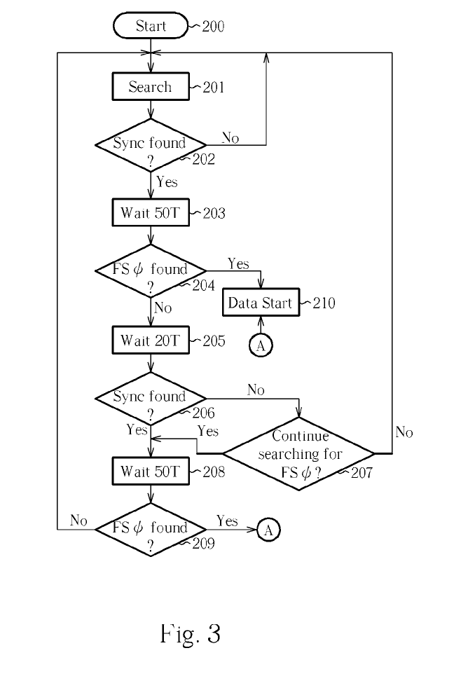

For a clearer understanding of this data start detection operation please refer to FIG. 3. FIG. 3 is a flowchart illustrating the method of detecting the start of user data according to an embodiment of the disclosed invention. Please note that the method detailed below requires the detection of FS0 for determining the start of user data. The steps of the operation are detailed below:

Step 200: Start.

Step 201: Search.

Step 202: Is a sync found? If yes go to Step 203, if no back to Step 201.

Step 203: Wait 50T.

Step 204: Is FS0 found? If yes go to Step 210, if no go to Step 205.

Step 205: Wait 20T.

Step 206: Is a sync found? If yes go to Step 207, if no go to Step 209.

Step 207: Continue searching for FS0? If yes go to Step 208, if no go back to Step 201.

Step 208: Wait 50T.

Step 209: Is FS0 found? If yes, go to Step 210, if no go back to Step 201.

Step 210: Data start.

The state machine includes five states: IDLE state, SEARCH state, SYNC_1 state, SYNC_2 state, and DATA_START state. The state machine summarizes operation of the aforementioned first, second, and third data start detection scenarios. The criterion of the transition from one state to another state includes the measured time interval, the sync pattern detection, or the sync ID identification. Since details of the data start detection of the present invention have been disclosed above, further description of the state machine is omitted for brevity.

The utilization of determining time intervals between detected sync patterns to determine the start of the third sync pattern FS0 (in some embodiments) or to directly determine the start of user data (in other embodiments) can be implemented by a variety of apparatus. Please note that all modifications described herein fall within the scope of the present invention, and further modifications that utilize the above-disclosed method for determining the start of user data also fall within the scope of the invention.

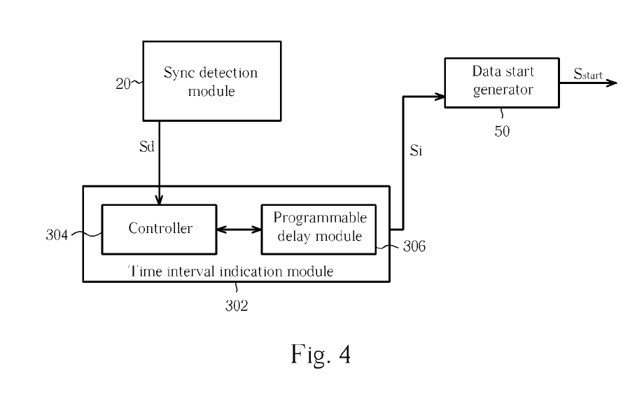

Please refer to FIG. 4. FIG. 4 is a diagram of an apparatus 300 for detecting the start of user data of a Blu-ray disc according to a second embodiment of the present invention. The hardware configuration and operation of the apparatus 300 is similar to that of the apparatus 100 shown in FIG. 2. The difference is that the time interval indication module 302 is implemented using a controller 304 and a programmable delay module 306. The controller 304 is designed to program the delay amount set to the programmable delay module 306 according to the aforementioned predetermined time intervals 50T, 70T, and 120T. In other words, until a next sync pattern is detected by the sync detection module 20, the programmable delay module 306 will update the delay amount by predetermined time intervals 50T, 70T, and 120T sequentially. Therefore, the programmable delay module 306 programs a delay amount set by the controller 304 to generate the signal Sᵢ. As can be seen, the data start generator 50 will be notified by the second signal Sᵢ when one of the predetermined time intervals 50T, 70T, and 120T expires. In short, the combination of the controller 304 and programmable delay module 306 acts like the combination of the controller 30 and counter mechanism 60 shown in FIG. 2. The same objective of indicating the time interval between two detected sync patterns is achieved.

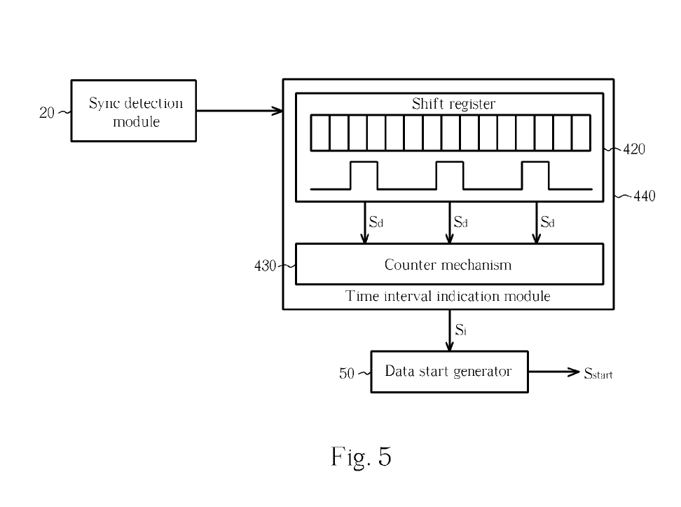

The time interval indication module can also be implemented by a shift register. Please refer to FIG. 5. FIG. 5 is a diagram of an apparatus 400 for detecting the start of user data of a Blu-ray disc according to a third embodiment of the present invention. The apparatus 400 comprises: a sync detection module 20; a time interval indication module 440, including a shift register 420 and a counter mechanism 430; and a data start generator 50. The bitstream is first input to the sync detection module 20 and the results are then sent to the time interval indication module 440 and input to the shift register 420. When a sync is detected, a ‘1’ will be registered by the shift register 420, whereas a negative result will register as a ‘0’. The whole shift register 420 can be searched or a series of detection windows can be placed at intervals along the shift register 420 to output a series of sync detection signals S_{d}. Detection of a ‘1’ indicates that a sync has been detected and will therefore cause S_{d} to be outputted. Because the detection windows are placed at predetermined intervals according to the time intervals between sync patterns of the Blu-ray disc, it can be instantly determined which sync pattern has been detected. If at least one sync detection signal S_{d} is received by the counter mechanism 430, a time interval can be set, the time interval being equivalent to the time between the detected sync pattern and the third sync pattern FS0, or the time between the detected sync pattern and the start of user data according to design requirements. When this time interval is reached, the signal Sᵢ will be output to the data start generator 50, for triggering the signal Sₛₜₐᵣₜ.

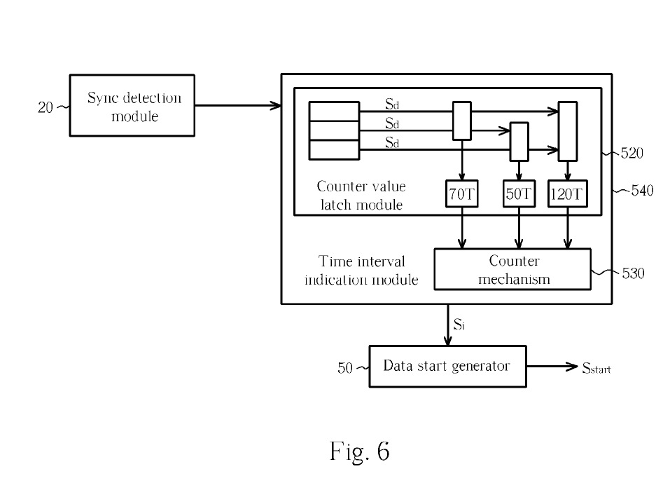

A modification of this embodiment utilizes a counter based structure in the time interval indication module. Please refer to FIG. 6. FIG. 6 is a diagram of an apparatus 500 for detecting the start of user data of a Blu-ray disc according to a fourth embodiment of the present invention. The apparatus 500 comprises: a sync detection module 20; a time interval indication module 540, including a counter value latch module 520 and a counter mechanism 530; and a data start generator 50. Each time a sync pattern/mark is detected, a counter in the counter value latch module is latched to output at least two sync detection signals S_{d}, and then a difference between two latched counter values is calculated to determine the time difference between the detected sync patterns, and therefore which sync patterns have been detected. A value can thereby be set to the counter mechanism corresponding to the time between the detected sync pattern and the third sync pattern FS0, or the time between the detected sync pattern and the start of user data according to design requirements. Please note that the determination module can be adjusted so that the difference between detected sync patterns falls in a range 50T±nT, 70T±nT, 120T±nT, where n is adjustable according to different design requirements.

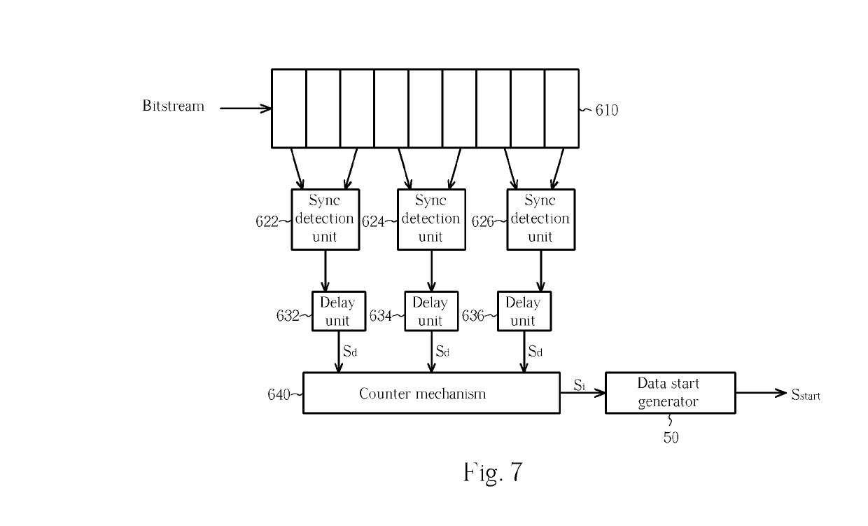

A further modification of the present invention utilizes a shift register to first buffer the Blu-ray bitstream, then carry out sync detection directly. Please refer to FIG. 7. FIG. 7 is a diagram of an apparatus 600 for detecting the start of user data of a Blu-ray disc according to a fifth embodiment of the present invention. The apparatus 600 comprises: a shift register 610; a plurality of sync detection units 622, 624, 626; a plurality of delay units 632, 634, 636; a counter mechanism 640; and a data start generator 50. In this embodiment the whole bitstream is initially input to the shift register 610. The plurality of syncs detection units 622, 624, 626 are placed at intervals corresponding to the expected location of each individual sync pattern. The plurality of delay units 632, 634, 636 can also be utilized to increase the sync detection units' detection range. Please note that the inclusion of the plurality of delay units 632, 634, 636 is not a requirement of the system but merely comprises one possible embodiment. If no delay units are included, the system can still fulfill the disclosed function of determining the start of data in a blu-ray disc. When a sync pattern is detected, a sync detection signal S_{d} will be generated to the counter mechanism 640, for setting a value to the counter mechanism corresponding to the time between the detected sync pattern and the third sync pattern FS0, or the time between the detected sync pattern and the start of user data according to design requirements. The signal Sᵢ will then be output to the data start generator 50, for triggering the signal Sₛₜₐᵣₜ. The disclosed system can be adjusted to comply with the above-mentioned data start scenarios; for example, it may be a requirement of the system that two sync patterns need to be detected for the data start signal to be sent. Alternatively, the system may require detection of all three sync patterns, or only one. These modifications all fall within the scope of the disclosed invention.

The present disclosure advantageously enables data on a Blu-ray disc to be accurately decoded while reducing the complexity of locating the start of user data in a cluster. Furthermore, the present disclosure enables data to be accurately decoded without requiring the detection of all three sync patterns.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A method for determining the start of user data in a data block on an optical disc, the optical disc having a plurality of sync patterns disposed between user data of two data blocks, the method comprising:
setting a plurality of predetermined time intervals;
detecting a first specific pattern and a second specific pattern; and
utilizing one of the predetermined time intervals and a time interval between the first specific pattern and the second specific pattern to determine the start of the user data.

2. The method of claim 1, wherein the step of determining the start of the user data comprises:
detecting a third specific pattern; and
utilizing the predetermined time intervals, the time interval between the first specific pattern and the second specific pattern, and a time interval between the second specific pattern and the third specific pattern to determine the start of the user data.

3. The method of claim 2, wherein the first specific pattern, the second specific pattern and the third specific pattern are sync patterns.

4. The method of claim 3, wherein the step of detecting the first sync pattern and the second sync pattern comprises:
if the first sync pattern is found, selecting a time interval from the predetermined time intervals and searching for the second sync pattern;
if a sync pattern is found when the selected time interval is reached, identifying the currently found sync pattern as the second sync pattern.

5. The method of claim 4, wherein a sync ID of the first sync pattern is selected from the group consisting of sync_1, sync_2, and FS0 complying with a Blu-ray disc specification.

6. The method of claim 5, wherein the time interval between the first sync pattern and the second sync pattern indicates that the first sync pattern has sync_1, and the step of determining the start of the user data comprises:
after the second sync pattern is found, detecting a third sync pattern; and
when the third sync pattern is detected, determining the start of the user data to be immediately following the third sync pattern.

7. The method of claim 6, wherein the step of detecting the third sync pattern comprises:
selecting another time interval from the predetermined time intervals and searching for the third sync pattern; and
if a sync pattern is found when the selected another time interval is reached, identifying the currently found sync pattern as the third sync pattern.

8. The method of claim 1, wherein the predetermined time intervals are determined according to parameters of a Blu-ray disc.

9. A method for determining the start of user data in a data block on an optical disc, the optical disc having a plurality of sync patterns disposed between user data of two data blocks, the method comprising:
detecting a first mark;
when the first mark is found, detecting an ID of the first mark (not disclosed yet!); and
when the ID of the first mark is found, determining the start of the user data according to the ID of the first mark.

10. The method of claim 9, wherein the mark is a sync pattern, and the ID is a sync ID.

11. The method of claim 10, wherein the sync ID of the first sync pattern is selected from the group consisting of sync_1, sync_2, and FS0 complying with a Blu-ray disc specification.

12. The method of claim 10, wherein the step of determining the start of the user data according to the sync ID of the first sync pattern comprises:
detecting a second sync pattern after the sync ID of the first sync pattern is found;
when the second sync pattern is found, detecting a sync ID of the second sync pattern; and
when the sync ID of the second sync pattern is found, determining the start of the user data according to the sync ID of the second sync pattern.

13. The method of claim 12, further comprising setting a plurality of predetermined time intervals, wherein the step of determining the start of the user data according to the sync ID of the second sync pattern comprises:
referencing the sync ID of the first sync pattern to select a time interval from the predetermined time intervals;
if the sync ID of the second sync pattern is found when the selected time interval is reached, determining the start of the user data according to the sync ID of the second sync pattern.

14. The method of claim 13, wherein the predetermined time intervals are determined according to parameters of a Blu-ray disc.

15. The method of claim 13, wherein a sync ID of the first sync pattern is selected from the group consisting of sync_1 and sync_2 complying with a Blu-ray disc specification.

16. The method of claim 15, wherein the sync ID of the first sync pattern is sync_1, and the step of determining the start of the user data according to the sync ID of the second sync pattern comprises:
detecting a third sync pattern after the sync ID of the second sync pattern is found;
when the third sync pattern is found, detecting a sync ID of the third sync pattern; and
when the sync ID of the third sync pattern is found, determining the start of the user data to be immediately following the third sync pattern.

17. The method of claim 16, wherein the step of determining the start of the user data to be immediately following the third sync pattern comprises:
referencing the sync ID of the second sync pattern to select another time interval from the predetermined time intervals; and
if the sync ID of the third sync pattern is found when the selected another time interval is reached, determining the start of the user data to be immediately following the third sync pattern.

18. The method of claim 12, wherein a sync ID of the first sync pattern is selected from the group consisting of sync_1, sync_2, and FS0 complying with a Blu-ray disc specification.

19. The method of claim 18, wherein the sync ID of the first sync pattern is sync_, and the step of determining the start of the user data according to the sync ID of the second sync pattern comprises:
detecting a third sync pattern after the sync ID of the second sync pattern is found;
when the third sync pattern is found, detecting a sync ID of the third sync pattern; and
when the sync ID of the third sync pattern is found, determining the start of the user data to be immediately following the third sync pattern.

20. The method of claim 19, further comprising setting a plurality of predetermined time intervals, wherein the step of determining the start of the user data to be immediately following the third sync pattern comprises:
referencing the sync ID of the second sync pattern to select a time interval from the predetermined time intervals;
if the sync ID of the third sync pattern is found when the selected time interval is reached, determining the start of the user data to be immediately following the third sync pattern.

21. The method of claim 10, further comprising setting a plurality of predetermined time intervals, wherein the step of determining the start of the user data according to the sync ID of the first sync pattern comprises:
referencing the sync ID of the first sync pattern to select a time interval from the predetermined time intervals; and
if a second sync pattern is found when the selected time interval is reached, determining the start of the user data according to the second sync pattern.

22. The method of claim 21, wherein the predetermined time intervals are determined according to parameters of a Blu-ray disc.

23. An apparatus for determining the start of user data in a data block on an optical disc, the optical disc having a plurality of specific patterns disposed between user data of two data blocks, the apparatus comprising:
a detection module, for detecting a first specific pattern and a second specific pattern; and
a time interval indication module, coupled to the detection module, for indicating a time interval between two specific patterns detected by the detection module, and determining the start of the user data by utilizing one of a plurality of predetermined time intervals and a time interval between the first specific pattern and the second specific pattern.

24. The apparatus of claim 23, further comprising:
a data start generator, coupled to the time interval indication module, for starting decoding of the data according to the start of the user data as indicated by the time interval indication module.

25. The apparatus of claim 23, wherein the detection module is a sync detection module, and the first specific pattern and the second specific pattern are sync patterns.

26. The apparatus of claim 25, wherein the sync detection module further detects a third sync pattern, the time interval indication module further indicates a time interval between the second sync pattern and the third sync pattern, and the time interval indication module utilizes the predetermined time intervals, the time interval between the first sync pattern and the second sync pattern, and the time interval between the second sync pattern and the third sync pattern to determine the start of the user data.

27. The apparatus of claim 26, wherein if the first sync pattern is found, the time interval indication module selects a time interval from the predetermined time intervals and the sync detection module searches for the second sync pattern; and if a sync pattern is found by the sync detection module when the selected time interval is reached as indicated by the time interval indication module, the time interval indication module identifies the currently found sync pattern as the second sync pattern.

28. The apparatus of claim 27, wherein a sync ID of the first sync pattern is selected from the group consisting of sync_1, sync_2, and FS0 complying with a Blu-ray disc specification.

29. The apparatus of claim 28, wherein the time interval between the first sync pattern and the second sync pattern indicates that the first sync pattern has sync_1; after the second sync pattern is found by the sync detection module, the sync detection module detects a third sync pattern; and when the third sync pattern is detected by the sync detection module, the time interval indication module determines the start of the user data to be immediately following the third sync pattern.

30. The apparatus of claim 29, wherein the time interval indication module selects another time interval from the predetermined time intervals and the sync detection module searches for the third sync pattern; and if a sync pattern is found by the sync detection module when the selected another time interval is reached as indicated by the time interval indication module, the time interval indication module identifies the currently found sync pattern as the third sync pattern.

31. The apparatus of claim 25, wherein the predetermined time intervals are determined according to parameters of a Blu-ray disc.

32. The apparatus of claim 25, wherein the time interval indication module comprises:
a controller, coupled to the sync detection module, for setting at least a counter threshold value according to a detection signal generated from the sync detection module, and for utilizing predetermined time intervals and the counter threshold value to determine the start of the user data; and
a counter mechanism, coupled to the controller and the data start generator, for informing the data start generator when the counter threshold value is met, thereby indicating the time interval between two sync patterns.

33. The apparatus of claim 32, wherein the controller comprises:
a shift register, for buffering the results from the sync detection module; and
a plurality of detection windows, coupled to the shift register, for searching the shift register for detection results, and outputting a plurality of detection signals to the counter mechanism according to the detection results to set the counter threshold value.

34. The apparatus of claim 32, wherein the controller comprises:
a counter value latch module, coupled to the counter mechanism, for latching a plurality of counters according to a plurality of sync detection results respectively received from the sync detection module, and for outputting a plurality of detection signals according to the latched plurality of counters respectively to set the counter threshold value.

35. The apparatus of claim 25, wherein the time interval indication module comprises:
a controller, coupled to the sync detection module, for setting at least a delay amount according to a detection signal generated from the sync detection module; and
a programmable delay module, coupled to the controller and the data start generator, for delaying the detection signal by the delay amount set by the controller, thereby indicating the time interval between two sync patterns.

36. The apparatus of claim 26, wherein the time interval between the first sync pattern and the second sync pattern, and the time interval between the second sync pattern and the third sync pattern are determined at the same time.

37. An apparatus for determining the start of user data in a data block on an optical disc, the optical disc having a plurality of specific patterns disposed between user data of two data blocks, the apparatus comprising:
a buffer module, for buffering a bitstream of the optical disc;
a plurality of detection units, coupled to the buffer module, for detecting at least a first specific pattern from the buffered bitstream, and outputting at least a first detection signal; and
a counter mechanism, coupled to the plurality of detection units, for receiving at least the first detection signal, and setting a counter threshold value according to a plurality of predetermined values and at least the first detection signal;
wherein the counter threshold value is utilized for determining the start of user data.

38. The apparatus of claim 37, further comprising:
a data start generator, coupled to the counter mechanism, for starting decoding of the data according to the start of the user data as indicated by the counter mechanism.

39. The apparatus of claim 37, further comprising:
a plurality of delay units, coupled to the plurality of detection units respectively, for increasing searching windows of the plurality of detection units respectively.

40. The apparatus of claim 38, wherein the plurality of detection units are sync detection units, and the first specific pattern is a sync pattern.

41. The apparatus of claim 40, wherein a sync ID of the first sync pattern is selected from the group consisting of sync_1, sync_2, and FS0 complying with a Blu-ray disc specification.

42. The apparatus of claim 41, wherein the predetermined time intervals are determined according to parameters of a Blu-ray disc.
